(19) United States
(12) Patent Application Publication
(10) Pub. No.: US 2020/0364177 A1
(43) Pub. Date: Nov. 19, 2020

(54) SAFETY COMMUNICATION MODULE

(71) Applicant: Oxti Corporation, Taipei (TW)

(72) Inventor: Po Huan LEE, Taipei (TW)

(21) Appl. No.: 16/413,724

(22) Filed: May 16, 2019

(51) Int. Cl. G06F 13/42; G06F 15/17; G06F 13/20; H04B 1/3816; H04W 4/60; H04W 4/80; H04W 12/00

(52) U.S. Cl. CPC G06F 13/4291; G06F 15/17; G06F 13/20; H04B 1/3816; G06F 2213/0002; H04W 4/80; H04W 12/001; G06F 2213/0016; H04W 4/60

(57) ABSTRACT

A communication module includes a master chip, an encrypted chip electrically connected to the master chip, and a communication chip electrically connected to the master chip, and the master chip includes an MOSI pin connected to an MOSI pin of the encrypted chip, and includes an MISO pin connected to an MISO pin of the encrypted chip, and includes a clock (CLK) pin connected to a CLK pin of the encrypted chip, and includes a CS pin connected to a CS pin of the encrypted chip, and the master chip includes an AUX_ANT pin and a MAIN_ANT pin connected to the communication chip.

### BACKGROUND OF THE INVENTION

### 1. Field of the Invention

The present invention relates to a communication module, and more particularly to a safety communication module including an improved structure or configuration for allowing the data and various information to be safely and effectively sent or transmitted and received and communicated in public internet or networking communication systems.

### 2. Description of the Prior Art

Various kind of typical communication modules have been developed and provided for telecommunication purposes, such as provided for detecting and/or monitoring vehicles, remote controlling vehicles, small wireless internet communication, wireless meter reading, access control system, cell paging, industrial information acquiring, wireless tag, personal identification, safety fire protection system, wireless remote control system, biological signal acquisition, hydrometeorological monitoring, robot controlling, digital audio, digital image transmission, smart home appliance, etc., the internet is communicated with public telecommunicating systems, communication module, and the like without being encrypted or encoded, such that the data or information transmitted and received and/or communicated will be cracked and attacked, malicious packet captured or the like, and especially, the safety and security facilities and the like will be cracked and pirated, and thus damages will be happened or resulted.

For example, U.S. Pat. No. 9,748,994 B2 to Maruyama, U.S. Pat. No. 9,853,831 B2 to Wain et al., and U.S. Pat. No. 9,887,727 B1 to Yokoyama disclose several of the typical communication modules that are also developed and provided for telecommunication purposes, such as for detecting and/or monitoring vehicles, remote controlling vehicles, etc.

However, the typical communication modules have not been encrypted or encoded and will be cracked and attacked easily, and will be malicious packet captured or the like.

The present invention has arisen to mitigate and/or obviate the afore-described disadvantages of the conventional communication modules.

### SUMMARY OF THE INVENTION

The primary objective of the present invention is to provide a safety communication module including an improved structure or configuration for allowing the data and various information to be safely and effectively sent or transmitted and received and communicated in public internet or networking communication systems.

In accordance with one aspect of the invention, there is provided a communication module comprising a master chip, an encrypted chip electrically connected to the master chip, and a communication chip electrically connected to the master chip, and the master chip including an MOSI pin connected to an MOSI pin of the encrypted chip, the master chip including an MISO pin connected to an MISO pin of the encrypted chip, the master chip including a clock (CLK) pin connected to a CLK pin of the encrypted chip, the master chip including a CS pin connected to a CS pin of the encrypted chip, and the master chip including an AUX_ANT pin and a MAIN_ANT pin connected to the communication chip for allowing the data and various information to be safely and effectively encrypted and sent or transmitted and received and communicated in public internet or networking communication systems.

A subscriber identity module (SIM) card slot may further be provided and electrically connected to the master chip, and the master chip includes a 7816_DATA pin connected a 7816_DATA pin of the SIM card slot, the master chip includes a 7816_CLK pin connected a 7816_CLK pin of the SIM card slot, and the master chip includes a 7816_RST pin connected a 7816_RST pin of the SIM card slot.

The master chip is electrically connected to the encrypted chip with a serial peripheral interface (SPI) bus, or electrically connected to the encrypted chip with an inter integrated circuit (I²C), or electrically connected to the encrypted chip with a general-purpose input/output (GPIO).

The master chip of the safety communication module is electrically connected to an electric facility, or the master chip of the safety communication module is electrically connected to an electric appliance which is electrically connected to the electric facility.

An electric reservoir may further be provided for providing an electric energy to the master chip and the encrypted chip and the communication chip. The electric reservoir includes a terminal, and an AC/DC converter.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a block diagram of a safety communication module in accordance with the present invention;

FIG. 2 is another block diagram similar to FIG. 1, illustrating the other arrangement of the safety communication module;

FIG. 3 is a further block diagram similar to FIGS. 1 and 2, illustrating the application of the safety communication module; and

FIG. 4 is a still further block diagram similar to FIGS. 1-3, illustrating the further arrangement of the safety communication module.

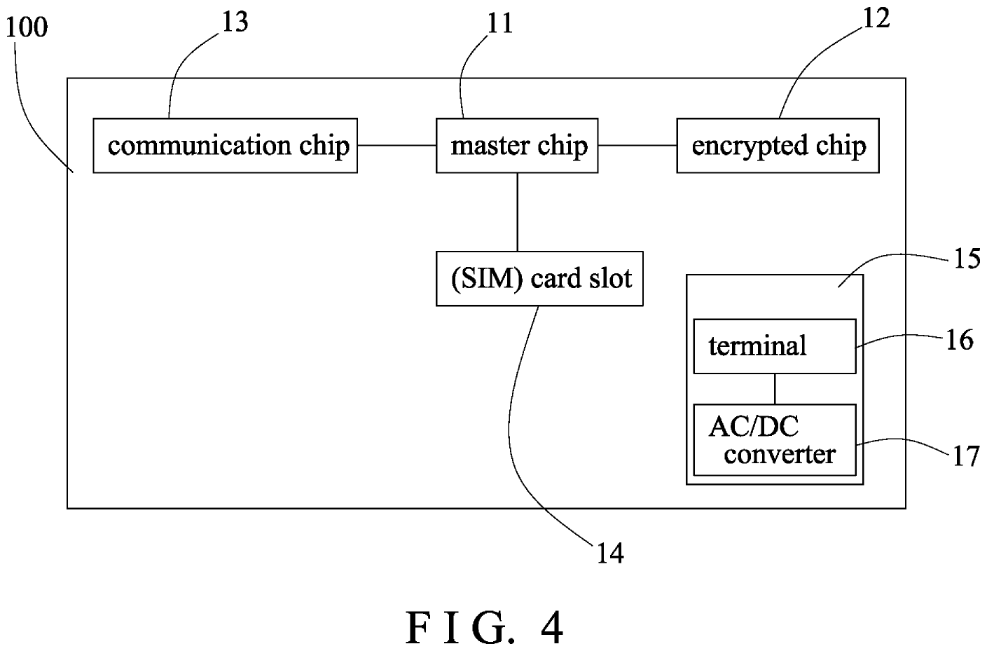

### DETAILED DESCRIPTION OF THE PREFERRED EMBODIMENT

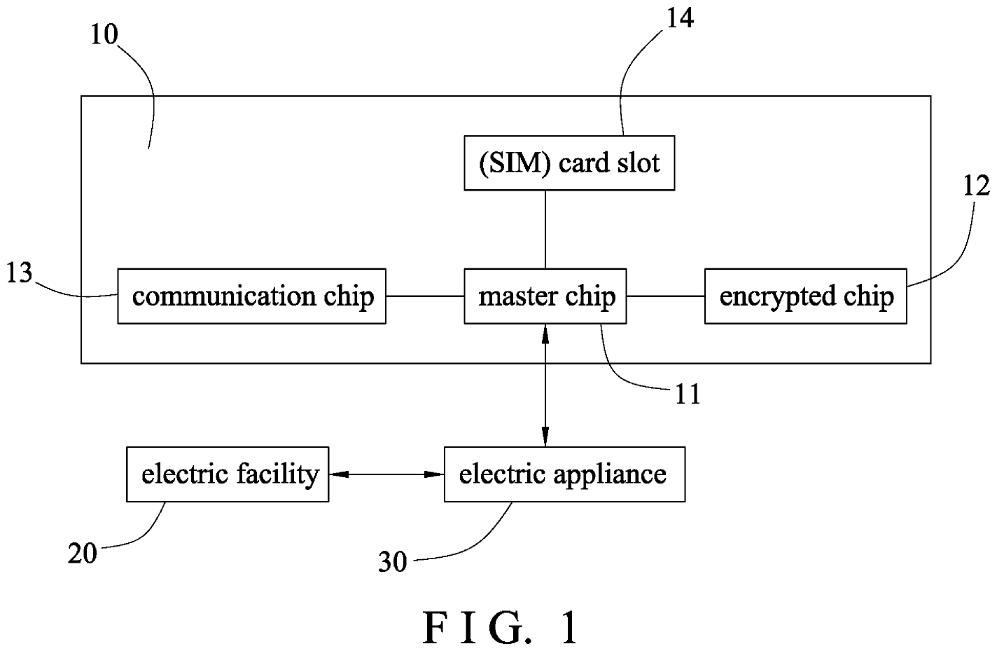

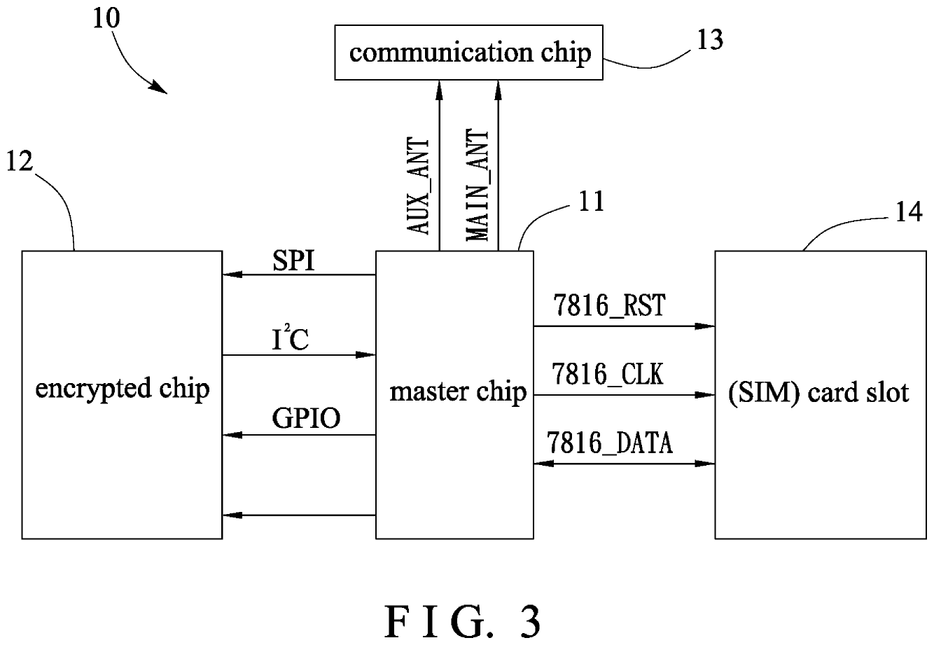

Referring to the drawings, and initially to FIGS. 1-3, a safety communication module in accordance with the present invention is generally indicated with a reference numeral 10 and comprises a primary or master chip 11, an encoded or encrypted chip 12 electrically connected or coupled to the master chip 11, a communication chip 13 also electrically connected or coupled to the master chip 11, and a subscriber identity module (SIM) card slot 14 also electrically connected or coupled to the master chip 11, and as shown in FIG. 3, the master chip 11 may be electrically connected or coupled to the encrypted chip 12 with a serial peripheral interface (SPI) bus or busbar, an inter integrated circuit (I²C), and/or a general-purpose input/output (GPIO). The master chip 11 may be electrically connected or coupled to or engaged with the SIM card slot 14 with a 7816 interface bus for electrically connecting or coupling to a SIM card (not illustrated) that is engaged with the SIM card slot 14.

The SPI bus is provided for hardware communication or the like, and includes one or more pins for engaging with the corresponding pins of the master chip 11 and the encrypted chip 12. For example, the MOSI pin (input) of the master chip 11 is connected or coupled to the MOSI pin (output) of the encrypted chip 12 with the SPI bus, the MISO pin of the master chip 11 is connected or coupled to the MISO pin of the encrypted chip 12 with the SPI bus, the clock (CLK) pin of the master chip 11 is connected or coupled to the (CLK) pin of the encrypted chip 12 with the SPI bus, and the CS pin of the master chip 11 is connected or coupled to the CS pin of the encrypted chip 12 with the SPI bus, in which SPI_MOSI and SPI_MISO provides the communicating passages or channels of the data and the information between the master chip 11 and the encrypted chip 12 with high and low level or the like. The master chip 11 provides the clock signals or information to the encrypted chip 12 with the SPI_CLK passage or channel, and provides the chip select signals or information to the encrypted chip 12 with the SPI_CS passage or channel.

The 7816 interface bus is provided for the master chip 11 to read and acquire the data and the information from the SIM card, and includes one or more pins for engaging with the corresponding pins of the master chip 11 and the SIM card slot 14. For example, the 7816_DATA pin of the master chip 11 is connected or coupled to the 7816_DATA pin of the SIM card slot 14 with the 7816 interface bus, the clock (CLK) pin of the master chip 11 is connected or coupled to the (CLK) pin of the SIM card slot 14 with the 7816 interface bus, and the reset (RST) pin of the master chip 11 is connected or coupled to the (RST) pin of the SIM card slot 14 with the 7816 interface bus. Accordingly, the master chip 11 provides the reset signals or information to the SIM card slot 14 with the 7816_RST passage or channel, and provides the clock signals or information to the SIM card slot 14 with the 7816_CLK passage or channel, and provides the data and the information to the SIM card with the 7816_DATA passage or channel with high and low level or the like. The AUX_ANT pins and the MAIN_ANT pins of the master chip 11 and the communication chip 13 are electrically connected or coupled or communicated with each other.

The safety communication module 10 may be wirelessly communicated with or transmitted to and from the cryptographic authentication server (CAS). In operation, the safety communication module 10 may wirelessly communicate or transmit or send the data and the information to the CAS, and the CAS may then send or transmit the data and the information to the other safety communication modules (not illustrated). Similarly, the safety communication module 10 may also be wirelessly communicated with the other safety communication modules directly, and may generate the identification keys or the like in the safety communication modules with the exchange algorithm and the like. While telecommunicating, the safety communication module 10 may encrypt or encode the data and the information with the keys, and then send or transmit the encrypted or encoded data and information to the other safety communication modules, and the other safety communication modules may then decrypt or decode the data and the information with the keys.

In operation, the master chip 11 of the safety communication module 10 may actuate or operate the SIM card to dial-up or to telecommunicate with the internet or networking communication systems through the communication chip 13, for example. After communicating or connecting or coupling to each other, the safety communication module 10 and the CAS may then send or transmit the data and the information to each other with or through the communication chip 13. The encrypted chip 12 may be used for memorizing or storing the safety certificate which may be provided as the safety certificate between the safety communication module 10 and the CAS, to ensure the uniqueness and the non-repudiation of the identity of the safety communication module 10. The CAS is responsible for the identity authentication and the generation of the session key or the like. The encrypted chip 12 may further be used for generating a one time session key or the like.

For example, the encrypted chip 12 may generate the random number with a random number generator (not illustrated) according to the asymmetry keys, in which the asymmetry keys include the public keys and the private keys, and in which the random number generator may also be selected from a pseudo or fake random number generator or the like. The master chip 11 of the safety communication module 10 may send or transmit the random number generated by the encrypted chip 12 to the CAS through the communication chip 13, and the CAS may then encrypt or emcode the data and the information with the keys of the encrypted chip 12 according to or dependent on the obtained random number, and then send back to the encrypted chip 12, the encrypted chip 12 may then decrypt or decode the data and the information with the keys, and then compare and determine whether the random numbers are the same or not. The communication chip 13 may be selected from a wireless or remote communication chip or the like.

The safety communication module 10 may further include a Universal Asynchronous Receiver Transmitter (UART) interface bus or busbar for telecommunicating with the internet or networking communication systems and the other facilities or mechanisms, such as smart lock that requires higher security. The communication chip 13 may be transmitted or telecommunicated with the mobile network, WIFI network, Narrow Band-Internet of Things (NB-IoT) network, or the LoRa network of the low power wide area network (LPWAN), and the communication chip 13 may be selected from an antenna communication chip or the like. The mobile network may be selected from Time Division-Synchronous Code Division Multiple Access (TD-SCDMA), TD-SCDMA Long Term Evolution (TD-LTE), Wideband Code Division Multiple Access (WCDMA), Code Division Multiple Access (CDMA), CDMA2000, or GAS network, or may be selected from 5G network or the like.

The master chip 11 of the safety communication module 10 may read and obtain the safety certificate and the asymmetry keys in the encrypted chip 12, and may encrypt or encode the safety certificate according to or dependent on the public keys of the asymmetry keys, and may then send or transmit the encrypted or encoded data and information to the CAS, and the CAS may then decrypt or decode the encrypted or encoded safety certificate according to or dependent on the CAS's own private keys, and may then verify and compare and/or judge and determine whether the decrypted safety certificate is identified or legal or not. If the decrypted safety certificate is identified and determined to be legal, then the safety communication module 10 is identified and determined to be legal. On the contrary, if the decrypted safety certificate is not identified and determined to be illegal, then the safety communication module 10 is determined to be illegal and no further data or information will be sent or transmitted or telecommunicated.

When the safety certificate sent or transmitted from the safety communication module 10 is identified and determined to be legal, the CAS may encrypt the CAS's own safety certificate with the public keys, and may then send or transmit the encrypted CAS safety certificate to the master chip 11 of the safety communication module 10, after the master chip 11 has received and obtained the encrypted CAS safety certificate, the master chip 11 may decrypt the encrypted CAS safety certificate with the obtained private keys of the asymmetry keys in order to obtain the decrypted CAS safety certificate, wherein the public keys of the asymmetry keys generated in the encrypted chip 12 is different from the public keys of the asymmetry keys generated in the CAS, and the private keys of the asymmetry keys generated in the encrypted chip 12 is different from the private keys of the asymmetry keys generated in the CAS.

The master chip 11 may then verify and judge the decrypted CAS safety certificate, if the CAS safety certificate is not identified and determined to be illegal, then the CAS is determined to be illegal and no further data or information will be sent or transmitted or telecommunicated. On the contrary, if the CAS safety certificate is legal, the data and the information may further be sent or transmitted or telecommunicated.

After the certification, the CAS will generate a new conversation private key, and will asymmetrically encrypt the conversation private key through or with the public keys and will send or transmit the encrypted conversation private key to the third legal electric facilities for allowing the third legal electric facilities and the safety communication module 10 to communicate with each other and with the symmetric encrypted data or information. Or, after the certification, the CAS may still be negotiated with the safety communication module 10, in order to exchange the algorithm and to generate the other new conversation private keys through or with the keys. It is to be noted that, while or when the other new conversation private keys are generated, the CAS and the master chip 11 of the safety communication module 10 will be communicated with each other after being symmetrically encrypted, such that a higher security may be obtained. In different communication processes or procedures, the conversation private keys, after being symmetrically encrypted, will be different from each other for preventing the conversation private keys from being cracked by the hackers.

It is to be noted that the conversation private keys are generated from the random number that is generated by the random number generator, specifically, the random number that is generated by the random number generator will be processed or treated with various arithmetic and logical operations by the CAS in order to generate the conversation private keys, the random numbers generated by the random number generator will be different from each other in each time such that the conversation private keys will also be different from each other in each time. Accordingly, in each communication process or procedure, the CAS may be negotiated with the safety communication module 10 in order to exchange the algorithm and to generate a new conversation private key which is different from the other conversation private keys, such that a higher security may be obtained in the communication processes or procedures, for preventing the conversation private keys from being cracked by the hackers.

In each communication process or procedure, the CAS and the encrypted chip 12 will generate the conversation private keys according to the common cardinality and based on the exchanging of the algorithm through or with the keys, the encrypted chip 12 will generate a conversation private key, and the CAS will also generate a conversation private key which is different from that generated by the encrypted chip 12. The safety communication module 10 may encrypt or decrypt the data or information with the conversation private keys read or received and obtained from the encrypted chip 12. For example, in one communication process or procedure, when or while the safety communication module 10 sending or transmitting the data or information to the CAS, the safety communication module 10 will encrypt the data or information to be sent or transmitted or telecommunicated through or with the conversation private keys generated by the encrypted chip 12, and then send or transmit the encrypted data or information to the CAS, and the CAS may then decrypt or decode the encrypted or encoded data or information according to or dependent on the CAS's own private keys, and may then process or treat the decrypted or decoded data or information.

When or while the CAS sending or transmitting the encrypted data or information to the safety communication module 10, the safety communication module 10 will decrypt or decode the encrypted or encoded data or information through or with the conversation private keys generated by the encrypted chip 12, and then will process or treat the decrypted or decoded data or information, such that the certificating process or procedure and the exchanging process or procedure of the keys will be much more precise and efficient. In the next communication process or procedure, the safety communication module 10 and the encrypted chip 12 will encrypt or decrypt the data or information with a different conversation private key, and may safely send or transmit the data or information before being cracked by the hackers, and the conversation private key will become fail and invalid after this communication process or procedure. In the further communication process or procedure, a further different conversation private key will be generated.

In the present invention, the safety communication module 10 may support the Transmission Control Protocol (TCP)/User Datagram Protocol (UDP) protocol, HyperText Transfer Protocol (HTTP) protocol, Constrained Application Protocol (COAP) protocol, Light Weight (LW) M2M protocol, and Message Queuing Telemetry Transport (MQTT) protocol. In the other circumstances, the safety communication module 10 may also support the other newly generated protocols for allowing the data or information to be safely and effectively sent or transmitted and received and communicated in public internet or networking communication systems. The safety communication module 10 may be selected from a SIM7600C chip, ME3630chip, or SIM7500 chip or the like, in which SIM7600C chip is an SMT packaged module and supports various frequencies, such as LTE CAT4 (LTEUE-Category) with a velocity of 150 Mbps, LTE-TDD/LTE-FDD (Long Term Evolution-Frequency Division Duplexing)/HSPA+/TD-SCDMA and Global System for Mobile Communications (GSM)/General Packet Radio Service (GPRS)/Enhanced Data rates for GSM Evolution (EDGE) which includes a stable performance, a small size and a high cost performance for transmitting Short Message Service (SMS) and data and information with a low power consumption. The size of the SIM7600C chip is 30*30*2.9 mm and is suitable for various compact products. The SIM7600C chip may be selected from a SIM7500CE or SIM7500X, etc. The SIM7600C chip, ME3630chip and SIM7500 chip may all be used for internet of things. The encrypted chip 12 supports Elliptic curve cryptography (ECC) encryption algorithm, RSA (Ron Rivest, Adi Shamir, Leonard Adleman) encryption algorithm, SM1 encryption algorithm, SM2 encryption algorithm, SM3 encryption algorithm, SM4 encryption algorithm, DES encryption algorithm, AES encryption algorithm, and SHA encryption algorithm etc., and may also support the other asymmetric and symmetric encryption algorithms, such as elliptic algorithm or the like. Specifically, the encrypted chip 12 supports SM2 encryption algorithm which is a high-intensity cryptographic algorithm that is one of the irreversible cryptographic algorithm and that may not be cracked so far, in addition, a one time conversation private key will be used in each telecommunication process or procedure, such that the certification and the transmission and the communication between the safety communication module 10 and the CAS may have a higher security and a non-repudiation.

Furthermore, the encrypted chip 12 may be selected from a CIU98320 chip or infineon 97 series chip, in which the power consumption of the CIU98320 chip is lower than 160 ρA/MHz, the CIU98320 chip and the infineon 97 series chip all support SM1, SM2, SM3, SM4 encryption algorithms, RSA encryption algorithm, ECC encryption algorithm, SHA (Secure Hash Algorithm) encryption algorithm, DES (Data Encryption Standard) encryption algorithm, AES (Advanced Encryption Standard) encryption algorithm, etc. The infineon 97 series chip may be selected from a SLE97 chip, a SLM97 chip, a SLI97 chip, etc. The SIM card may be engaged with the SIM card slot 14 and may then be electrically connected or coupled to the master chip 11 of the safety communication module 10, and the safety communication module 10 may then control and actuate or operate the SIM card to dial-up or to telecommunicate with the internet or networking communication systems, such as the CAS, through the communication chip 13.

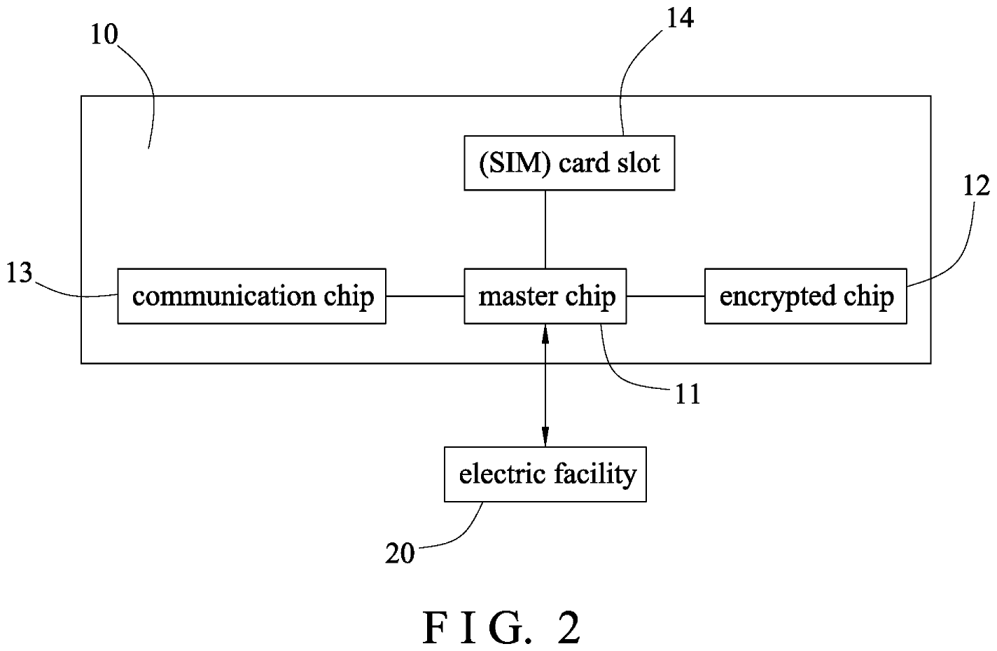

As shown in FIG. 2, the master chip 11 of the safety communication module 10 may be directly and electrically connected or coupled to an electric facility 20, such as a portable phone, a mobile phone, a notebook, an I-pad, a personal computer, or the like, or as shown in FIG. 1, the master chip 11 of the safety communication module 10 may be indirectly and electrically connected or coupled to the electric facility 20 with an electric appliance 30, such as a portable or wearable wisdom bracelet, a smart watch, an electronic card or the like, which may be used for network communication (such as 4G, WiFi, etc) and which may provide the authentication and the authorization to and from the safety communication module 10, the electric facility 20 may be telecommunicated with the electric appliance 30 with a USB, a bluetooth BT or the like, and may be telecommunicated with the master chip 11 of the safety communication module 10 with the APP software that is stored and provided in the electric appliance 30, and may also provide the authentication and the authorization to and from the safety communication module 10.

When the safety certificate introduces the encryption algorithm legally from a third party, it may send or submit a third party public key to the CAS, and the CAS may certify and sign the third party public key with a CAS private key, in order to provide the safety certificate for the third party. As shown in FIG. 3, the safety communication module 100 may further include an electric power source or reservoir 15 electrically connected or coupled to the master chip 11 and/or the encrypted chip 12 and/or the communication chip 13 for providing an electric power or energy to the master chip 11 and the encrypted chip 12 and the communication chip 13, the electric power reservoir 15 may include a socket or port or terminal 16 for electrically connecting or coupling to the outer electric power source or reservoir or the like, and may include an AC/DC converter 17 electrically connected or coupled to the electric power reservoir 15 for receiving the electric power or energy and for converting the alternative electric power or energy to the direct electric power or energy that may be used for the safety communication module 10.

The safety communication module 10 may further include a Universal Asynchronous Receiver Transmitter (UART) interface bus or the like for allowing the safety communication module 10 to be electrically connected or coupled to the other outer appliances or facilities, such as the wisdom locks, with cables or wires. The safety communication module 10 may further include a debug interface for debugging the safety communication module 10 and for ensuring the proper actuation or operation of the safety communication module 10.

Accordingly, the safety communication module in accordance with the present invention includes an improved structure or configuration for allowing the data and various information to be safely and effectively sent or transmitted and received and communicated in public internet or networking communication systems.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A communication module comprising:
a master chip,
an encrypted chip electrically connected to said master chip, and
a communication chip electrically connected to said master chip, and
said master chip including an MOSI pin connected to an MOSI pin of said encrypted chip, said master chip including an MISO pin connected to an MISO pin of said encrypted chip, said master chip including a clock (CLK) pin connected to a CLK pin of said encrypted chip, said master chip including a CS pin connected to a CS pin of said encrypted chip, and said master chip including an AUX_ANT pin and a MAIN_ANT pin connected to said communication chip.

2. The communication module as claimed in claim 1 further comprising a subscriber identity module (SIM) card slot electrically connected to said master chip, said master chip including a 7816_DATA pin connected a 7816_DATA pin of said SIM card slot, said master chip including a 7816_CLK pin connected a 7816_CLK pin of said SIM card slot, and said master chip including a 7816_RST pin connected a 7816_RST pin of said SIM card slot.

3. The communication module as claimed in claim 1, wherein said master chip is electrically connected to said encrypted chip with a serial peripheral interface (SPI) bus.

4. The communication module as claimed in claim 1, wherein said master chip is electrically connected to said encrypted chip with an inter integrated circuit (PC).

5. The communication module as claimed in claim 1, wherein said master chip is electrically connected to said encrypted chip with a general-purpose input/output (GPIO).

6. The communication module as claimed in claim 1, wherein said master chip of said safety communication module is electrically connected to an electric facility.

7. The communication module as claimed in claim 6, wherein said master chip of said safety communication module is electrically connected to an electric appliance which is electrically connected to said electric facility.

8. The communication module as claimed in claim 1 further comprising an electric reservoir for providing an electric energy to said master chip and said encrypted chip and said communication chip.

9. The communication module as claimed in claim 8, wherein said electric reservoir includes a terminal, and an AC/DC converter.
